(19) United States
(12) Patent Application Publication
(10) Pub. No.: US 2004/0249694 A1
(43) Pub. Date: Dec. 9, 2004

(54) Project management method and system

(76) Inventor: Sheng Chi Luo, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/863,157

(22) Filed: Jun. 7, 2004

(30) Foreign Application Priority Data
Jun. 6, 2003 (TW) 92115462

(51) Int. Cl. G06F 17/60

(52) U.S. Cl. 705/8

(57) ABSTRACT

A computer-enabled project management method includes the steps of: (a) receiving a user ID and password and determining whether the user is an authorized user; (b) determining whether the user is a project manager; (c) recording working statuses of various work items; (d) verifying the working status records; (e) integrating all verified working status records of a selected project into a working status report; (f) calculating an expected completion ratio as at a current time and a priority index for each work item; (g) determining whether a priority index of any work item is greater than or equal to its warning index; and (h) generating a warning alarm and transmitting the warning alarm to a corresponding operator for processing of a work item preferentially if the priority index of the work item is greater than or equal to its warning index. A related project management system for implementing the project management method is also provided.

### BACKGROUND OF THE INVENTION

1. Field of the Invention

The present invention relates generally to automated methods and systems for project management, and particularly to a computer-enabled method and system for project management.

2. Background of the Invention

According to the American Project Management Association, the definition of “project management” is using specialty knowledge, skills, tools and/or methods to make a project good. Modem project management technologies originated from the Manhattan project of nuclear weapons development in the United States. The technology of project management has achieved great progress in the following period of about sixty years. The present technology used in project management is Gantt charts and PERT (project evaluation and review technique) charts. A Gantt chart is for scheduling work items according to required times, and for recording actual required times. A PERT chart describes relationships of work items, and uses a line with an arrowhead to indicate processing sequences of the work items. Application software such as Microsoft's Project can be used for drawing Gantt charts and PERT charts.

The art of Gantt chart drawing is disclosed in patents such as U.S. Pat. No. 6,282,514 issued on Aug. 28, 2001 and entitled “Device and Method for Project Management.” The patent provides a device for generating a Gantt chart made up of at least one schedule bar. The Gantt chart generation device includes a display unit showing the Gantt chart, an input unit receiving input to mark a point at a desired position on the display, a Gantt-chart-generation processing unit generating a schedule bar having a start point and an end point obtained by setting the start point at a first position indicated by the input unit and setting the end point at a second position indicated by the input unit, and a work-step-division processing unit dividing the schedule bar into a plurality of work steps at a plurality of third positions indicated by the input unit.

An obvious disadvantage of the patent is that the system/method described therein is merely directed to the drawing of Gantt charts. However, with the ongoing development of project management techniques, other tasks such as recording of working statuses, verification of working status records and transmission of warning alarms need to be catered for. In particular, there is no known project management method and system which can record working statuses of various work items, verify working status records, and transmit a warning alarm to a corresponding operator and/or project manager if any project is calculated to have a current urgent status.

### SUMMARY OF THE INVENTION

A main objective of the present invention is to provide a project management method and system which can record working statuses of various work items, and which can verify the working status records.

Another objective of the present invention is to provide a project management method and system which can calculate priority indexes for work items, compare each priority index with a benchmark index, and transmit a warning alarm to a corresponding operator and/or project manager for processing of a work item preferentially if the priority index of the work item is deemed to be urgent.

To achieve the above objectives, a preferred project management method according to the present invention comprises the steps of: (a) receiving a user ID and password and determining whether the user is an authorized user; (b) determining whether the user is a project manager; (c) recording working statuses of various work items; (d) verifying the working status records; (e) integrating all verified working status records of a selected project into a working status report; (f) calculating an expected completion ratio as at a current time and a priority index for each work item; (g) determining whether a priority index of any work item is greater than or equal to its warning index; and (h) generating a warning alarm and transmitting the warning alarm to a corresponding operator for processing of a work item preferentially if a priority index of the work item is greater than or equal to its warning index.

A project management system is also provided by the present invention. The project management system comprises a database server for gathering, storing and inquiring of data used or generated in implementing the project management system, a web server, a plurality of browsers and an application server. The application server comprises: an authority management module for identifying and managing authorities assigned to different users; a project creation module for creating new projects and work items of the new projects; a working status record module for recording working statuses of various work items; a record verification module for verifying the working status records; a report generation module for integrating all verified working status records of a selected project into a working status report; a warning alarm module for generating a warning alarm and transmitting the warning alarm to a corresponding operator and/or project manager if any work item is deemed to be urgent; a work item prioritizing module for prioritizing the work items according to their priority indexes; and a displaying module for displaying the work items in their prioritized sequence.

The warning alarm module comprises an expected completion ratio calculation sub-module for calculating an expected completion ratio as at a current time for each work item; a priority index calculation sub-module for calculating the priority index for each work item; a warning identification sub-module for determining whether a priority index of a work item is greater than or equal to a corresponding warning index; and a warning alarm generation sub-module for transmitting a warning alarm to a corresponding operator and/or project manager for processing of a work item preferentially if the priority index of the work item is greater than or equal to its warning index.

Other objects, advantages and novel features of the present invention will be drawn from the following detailed description of a preferred embodiment thereof with the attached drawings in which:

### BRIEF DESCRIPTION OF THE DRAWINGS

FIG. 1 is a schematic diagram of hardware infrastructure and software function modules of a project management system according to the preferred embodiment of the present invention;

FIG. 2 is a schematic diagram of function sub-modules of a warning alarm module of an application server of the project management system of FIG. 1;

FIG. 3 is a schematic illustration of an exemplary interface for creating work items by utilizing the project management system of FIG. 1;

FIG. 4 is a flowchart of a preferred project management method according to the present invention;

FIG. 5 is a flowchart of a preferred method for generating a warning alarm according to the present invention; and

FIG. 6 is a schematic illustration of an exemplary operation interface for recording working statuses by utilizing the project management system of FIG. 1.

### DETAILED DESCRIPTION OF THE INVENTION

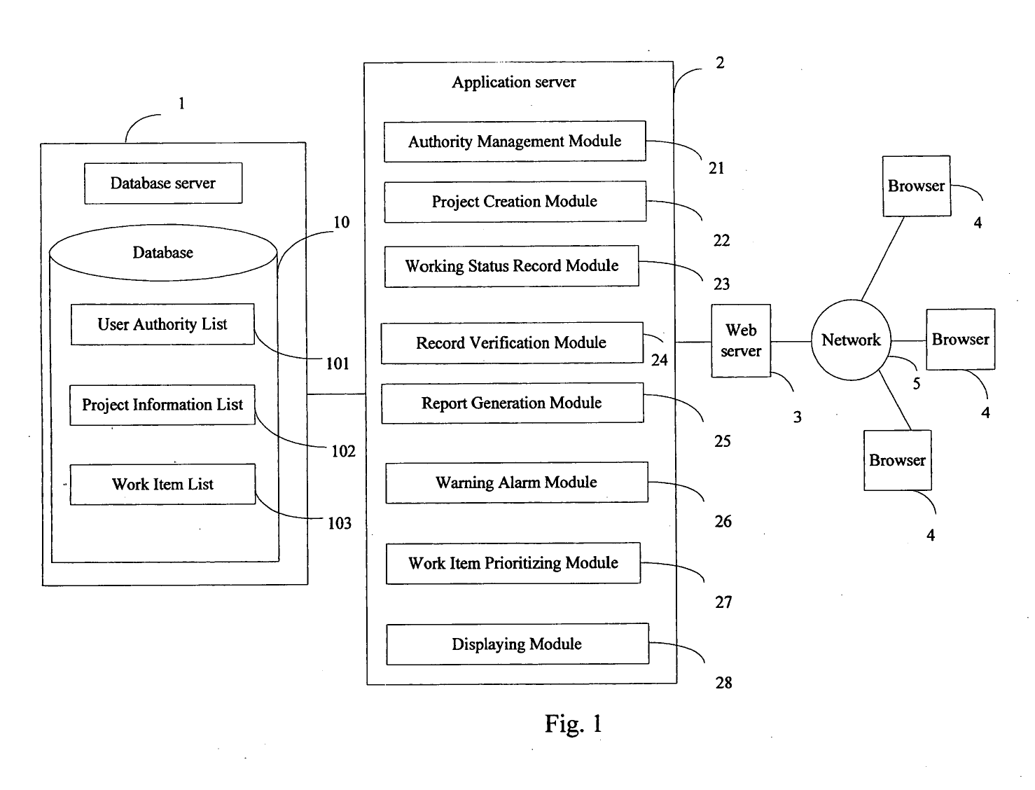

FIG. 1 is a schematic diagram of hardware configuration and function modules of a project management system according to the preferred embodiment of the present invention. The project management system comprises a database server 1, an application server 2, a web server 3, and a plurality of browsers 4. The web server 3 is connected with the browsers 4 through a network 5. The web server 3 provides an interactive user interface for project managers using the project management system to create new projects and work items of the new projects and verify working status records, and for operators using the project management system to record working statuses of various work items. Typically, an operator records an up-to-date working status of his/her work item on a daily basis until the work item is completed. The database server 1 is used for gathering, storing and inquiring of data used or generated in implementing the project management system. A database 10 stored in the database server 1 stores a user authority list 101, a project information list 102, and a plurality of work item lists 103 (only one shown). The application server 2 is programmed to execute a number of applications in order to implement various functions of the project management system.

The user authority list 101 stores information on authorities assigned to different users. Such information includes fields for “user name,” “user type” and “password.” The word “user” as used herein can be considered as including project managers and operators who make use of the project management system. The field “user type” provides a dropdown menu for users to select user types from a predetermined user type list.

The project information list 102 records information on various projects. Information on each project comprises fields for “project name,” “project manager,” “starting time” and “expected finish-time.” The projects that are controlled and managed using the project management system may for example be engineering projects, software development projects, or professional service projects. In the preferred embodiment of the present invention, a project includes at least one work item. For example, a software development project may include three work items: demand analysis, system analysis and design, and software modification and execution.

Each work item list 103 is used for recording information on a particular work item. The information on each work item includes fields for “work item name,” “working status records,” “operator,” “starting time,” “expected finish-time,” “project name,” “importance index,” “warning index,” “expected completion ratio,” “priority index,” and “actual finish-time.” The importance index represents a degree of importance of a corresponding work item. The priority index is a dynamic value for recording a processing sequence of the work item. The warning index is a static value, which is a critical value predetermined by project managers. When the priority index of the work item is greater than or equal to the critical value, the project management system transmits a warning alarm to a corresponding operator and/or project manager for processing of the work item preferentially. The field of “working status records” comprises three sub-fields: “working status,” “processing status,” and “verifying.” The sub-field of “processing status” records a current processing rate of the work item. The sub-field of “verifying” is a Boolean value, which is used for recording whether the working status records have been verified. A Boolean value of “0” means that the working status records have not been verified. A Boolean value of “1” means that the working status records have been verified.

The application server 2 is for creating new projects and work items of the new projects, for recording working statuses, for calculating priority indexes, and for generating working status reports. The application server 2 comprises an authority management module 21, a project creation module 22, a working status record module 23, a record verification module 24, a report generation module 25, a warning alarm module 26, a work item prioritizing module 27, and a displaying module 28.

The authority management module 21 is for identifying and managing user authorities based on the user authority list 101. The project creation module 22 is programmed to create new projects and work items of the new projects, and to obtain information on the new projects and work items. The project creation module 22 adds a new work item list 103 to store information on the work items. The working status record module 23 is used for recording working statuses for work items in the field of “working status records” of the work item lists 103, and for each such work item sets a Boolean value of a corresponding sub-field of “verifying” as “0.” The record verification module 24 verifies working status records, and for each such working status record sets a Boolean value of the corresponding sub-field of “verifying” as “1.” The report generation module 25 selects a project and generates working status reports in a predetermined format based on all verified working status records of the selected project. The predetermined format may be Microsoft Word, Microsoft Excel, or any other suitable format. The warning alarm module 26 is for calculating a priority index for each work item based on the working status records, for determining whether a priority index of any work item is greater than or equal to its warning index, and for transmitting a warning alarm to a corresponding operator and/or project manager for processing of a work item preferentially if the priority index of the work item is greater than or equal to its warning index. The work item prioritizing module 27 is for prioritizing work items according to their priority indexes. The displaying module 28 is used for displaying the work items in their prioritized sequence.

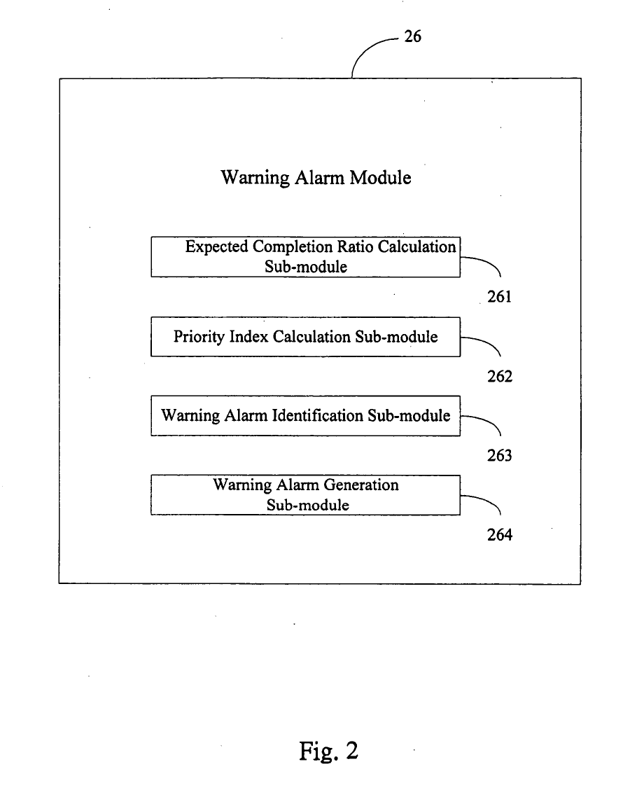

FIG. 2 is a schematic diagram showing function sub-modules of the warning alarm module 26. The warning alarm module 26 comprises an expected completion ratio calculation sub-module 261, a priority index calculation sub-module 262, a warning alarm identification sub-module 263, and a warning alarm generation sub-module 264. The expected completion ratio calculation sub-module 261 calculates an expected completion ratio as at a current time for each work item according to a starting time, an expected finish-time of the work item and the current time, and fills the expected completion ratio as at the current time in a corresponding field of a work item list 103. The expected completion ratio as at the current time is calculated according to the following formula: (expected finish-time-starting time)/(current time-starting time)*100%. Thus for example an expected completion ratio calculated on a particular day is different from the expected completion ratio calculated on the previous day, and different from an expected completion ratio calculated on the following day. The priority index calculation sub-module 262 calculates a priority index for each work item according to an importance index, an expected completion ratio as at a current time and a current processing status of the work item, and fills the priority index in a corresponding field of the work item list 103. The priority index is calculated according to the following formula: importance index*(1-expected completion ratio as at the current time)/(1-current processing status). The warning identification sub-module 263 determines whether a priority index of any work item is greater than or equal to its warning index. If a priority index of a work item is greater than or equal to its warning index, the warning alarm generation module 264 generates a warning alarm and transmits the warning alarm to a corresponding operator and/or project manager for processing of the work item preferentially.

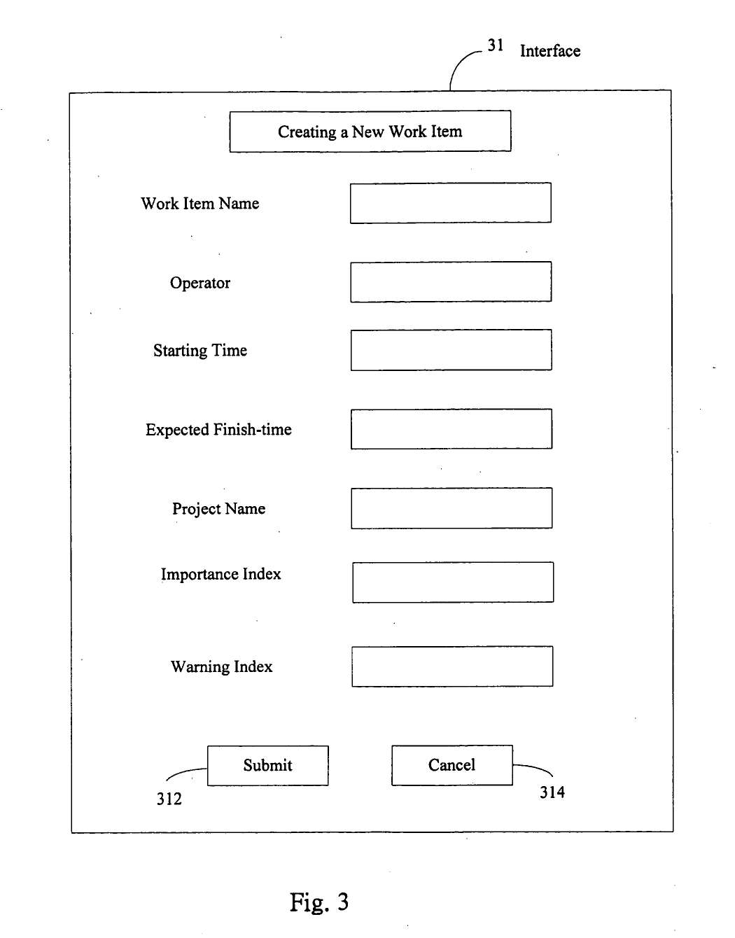

FIG. 3 is a schematic diagram of an exemplary interface 31 for creating a work item of a new project by utilizing the project management system. A project manager can use any one of the browsers 4 to log on the web server 3 for creating a new project and work items of the new project. Through the interface 31, the project manager can input information to various fields including work item name, operator, starting time, expected finish-time, project name, importance index and warning index. The project creation module 22 adds a new work item list 103 in the database 10 to store information on the work item if the project manager operates a “Submit” key 312; otherwise the operation is canceled if the project manager operates a “Cancel” key 314.

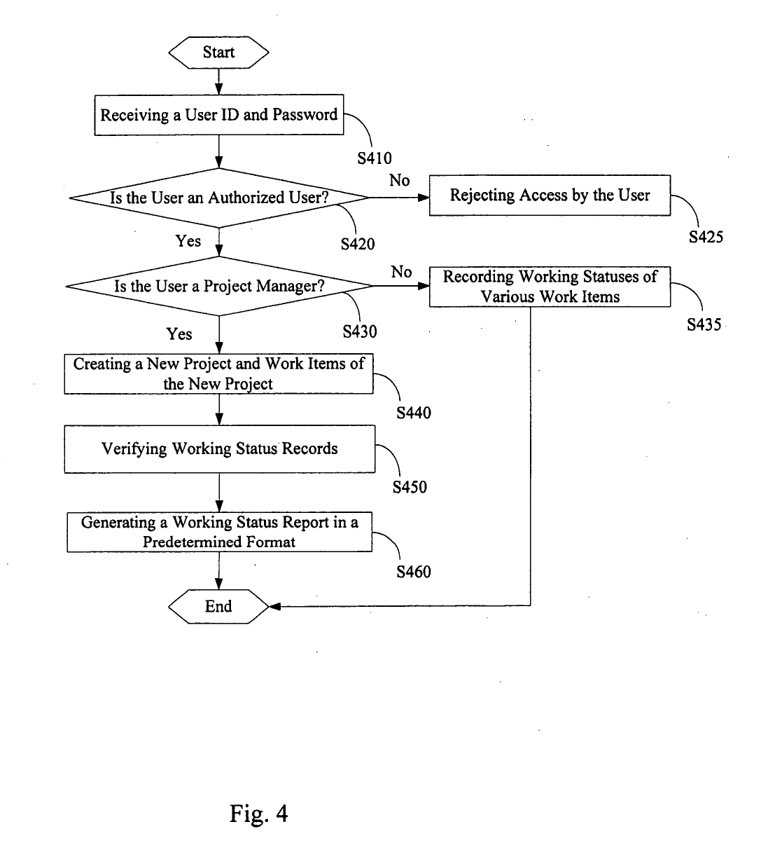

FIG. 4 is a flowchart illustrating a preferred project management method according to the present invention. In step S410, the authority management module 21 receives a user ID and password. In step S420, the authority management module 21 determines whether the user is an authorized user by identifying the user ID and password according to the user authority list 101. If the user is not an authorized user, in step S425, the authority management module 21 rejects access by the user. If the user is an authorized user, in step S430, the authority management module 21 determines whether the user is a project manager according to the user authority list 101. If the user is not a project manager, in step S435, the working status record module 23 records working statuses of various work items, and for each such work item sets a Boolean value of a corresponding sub-field of “verifying” as “0.” Otherwise, in step S440, the project creation module 22 creates a new project and work items for the new project, and obtains information on the project and the work items. In step S450, the record verification module 24 verifies the working status records and for each such working status record sets a Boolean value of the corresponding sub-field of “verifying” as “1.” In step S460, the report generation module 25 selects a project and integrates all verified working status records of the selected project into a working status report in a predetermined format.

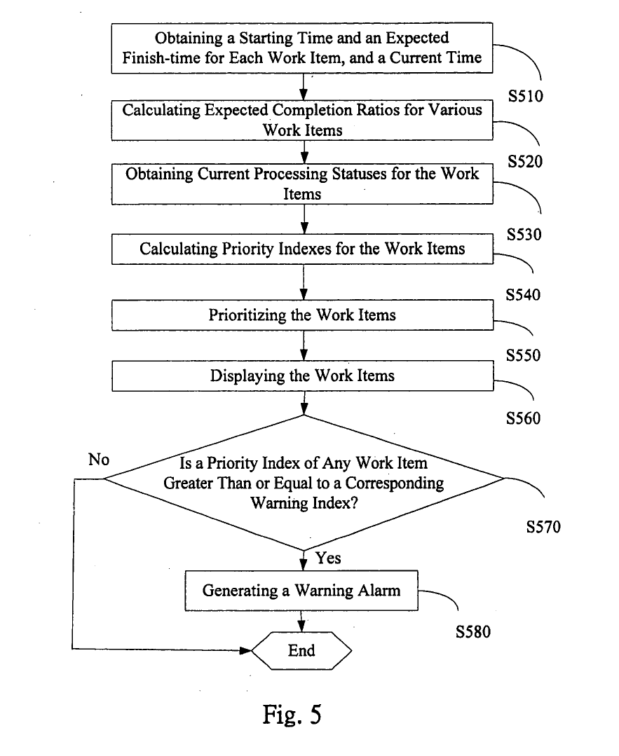

FIG. 5 is a flowchart of a preferred method for generating a warning alarm according to the present invention. In step S510, the expected completion ratio calculation sub-module 261 obtains a starting time and an expected finish-time of each work item from the database 10 and a current time. In step S520, the expected completion ratio calculation sub-module 261 calculates an expected completion ratio as at a current time for each work item based on the starting time and the expected finish-time of the work item and the current time, and fills the expected completion ratio as at the current time in a corresponding field of a relevant work item list 103. In step S530, the priority index calculation sub-module 262 obtains current processing statuses of various work items from the work item list 103. In step S540, the priority index calculation sub-module 262 calculates a priority index of each work item based on the importance index, the expected completion ratio as at the current time and the current processing status of the work item, and fills the priority index in a corresponding field of the work item list 103. In step S550, the work item prioritizing module 27 prioritizes the work items according to their priority indexes. In step S560, the displaying module 28 displays the work items in their prioritized sequence. In step S570, the warning identification sub-module 263 determines whether a priority index of any work item is greater than or equal to a corresponding warning index. If a priority index of any work item is greater than or equal to its warning index, in step S580, the warning alarm generation sub-module 264 generates a warning alarm and transmits the warning alarm to a related operator and/or project manager for processing of the work item preferentially. Otherwise, the procedure is ended.

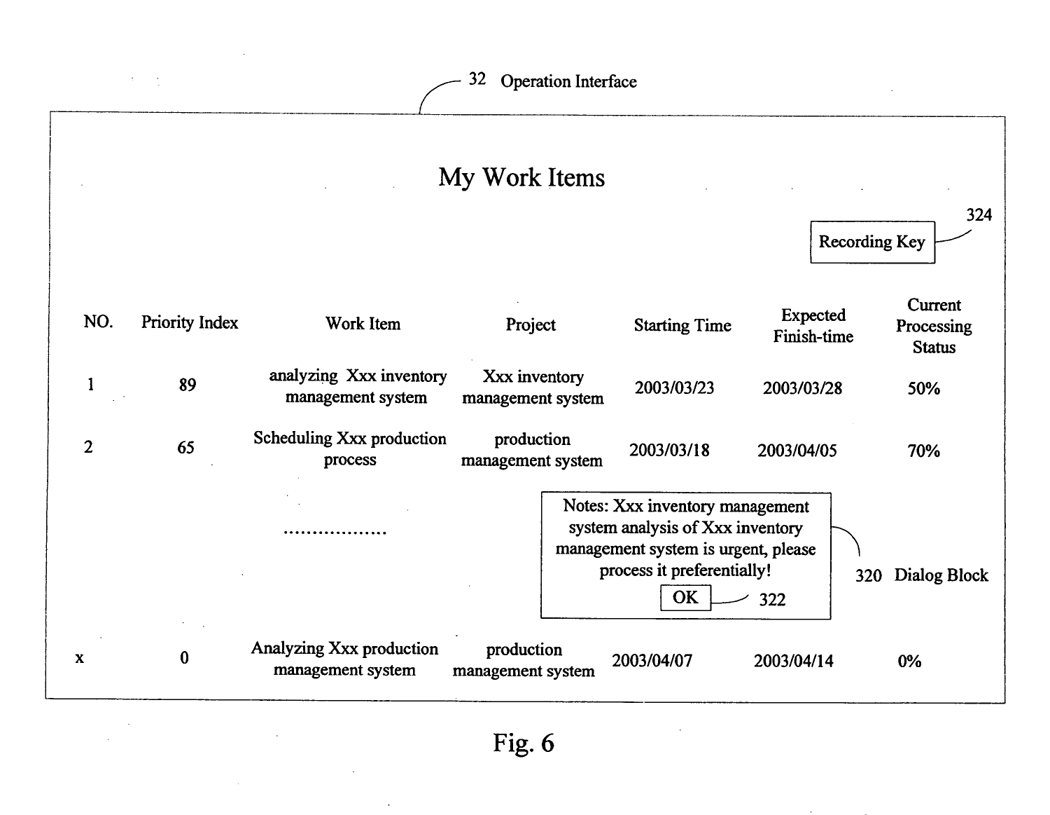

FIG. 6 is a schematic diagram of an operation interface 32 for recording working statuses by utilizing the project management system. The operation interface 32 displays information on all work items undertaken by a selected operator according to their priority indexes. If a priority index of a work item is greater than or equal to its warning index, the operation interface 32 displays a dialog block 320 containing a warning. The operator can process the work item immediately after operating an “OK” key 322 in the dialog block 320. If the operator double-clicks a work item in the operation interface 32 using a computer mouse, detailed information on the work item is displayed. The detailed information comprises work item name, operator, expected completion ratio as at a current time, current processing status, importance index, priority index, warning index, starting time, expected finish-time, actual finish-time, and working status records. The operator can select a work item and click a recording key 324 to record the working statuses of the selected work item.

In general, the project management method and system of the present invention may take forms other than what is described above. While preferred embodiments for carrying out the present invention have been described in detail, those familiar with the art to which the invention relates will recognize various alternative designs and embodiments for practicing the present invention. These alternative embodiments are within the scope of the present invention, which is defined by the claims appended hereto and allowable equivalents thereof.

What is claimed is:

1. A computer-enabled project management method, comprising the steps of:
(a) receiving a user ID and password;
(b) determining whether the user is an authorized user;
(c) determining whether the user is a project manager;
(d) recording working statuses of various work items if the user is not a project manager;
(e) creating a new project and work items for the new project, and obtaining information on the project and work items if the user is a project manager;
(f) verifying the working status records; and
(g) integrating all verified working status records of a selected project into a working status report.

2. The project management method according to claim 1, further comprising the step of rejecting access by the user if the user is not an authorized user.

3. The project management method according to claim 1, wherein the information on the work items comprises importance indexes and warning indexes.

4. The project management method according to claim 1, further comprising the step of generating a warning alarm according to the working status records.

5. The project management method according to claim 4, wherein the step of generating a warning alarm according to the working status records comprises the step of:
obtaining a starting time and an expected finish-time for each work item and a current time;
calculating an expected completion ratio as at a current time for each work item based on the starting time, and the expected finish-time of the work item and the current time;
obtaining current processing statuses for the work items;
calculating priority indexes for the work items;
determining whether a priority index of any work item is greater than or equal to a corresponding warning index; and
generating a warning alarm and transmitting the warning alarm to an operator for processing a work item preferentially if the priority index of the work item is greater than or equal to its warning index.

6. The project management method according to claim 4, wherein the step of generating a warning alarm according to the working status records further comprises the steps of:
prioritizing the work items according to the priority indexes; and displaying the prioritized work items in their prioritized sequence.

7. A computer-enabled project management system comprising:
a database server;
a web server;
a plurality of browsers; and
an application server comprising:
a working status record module for recording working statuses;
a record verification module for verifying working status records;
a report generation module for integrating all verified working status records of a selected project into a working status report; and
a warning alarm module for generating a warning alarm and transmitting the warning alarm to a corresponding operator.

8. The project management system according to claim 7, wherein the application server further comprises an authority management module for identifying and managing authorities assigned to different users.

9. The project management system according to claim 7, wherein the application server further comprises a project creation module for creating new projects and work items of the new projects.

10. The project management system according to claim 7, wherein the warning alarm module comprises:
an expected completion ratio sub-module for calculating expected completion ratios as at respective current times;
a priority index calculation sub-module for calculating priority indexes;
a warning identification sub-module for determining whether a priority index of any work item is greater than or equal to its warning index; and
a warning alarm generation sub-module for generating a warning alarm, and for transmitting the warning alarm to an operator for processing of a work item preferentially if the priority index of any work item is greater than or equal to its warning index.

11. The project management system according to claim 7, wherein the application server further comprises a work item prioritizing module for prioritizing the work items according to the priority indexes.

12. The project management system according to claim 7, wherein the application server further comprises a displaying module for displaying the work items in the prioritized sequence.

13. A method of generating a warning alarm according to working status records comprises the step of:
obtaining a starting time and an expected finish-time for each work item and a current time;
calculating an expected completion ratio as at a current time for each work item based on the starting time, and the expected finish-time of the work item and the current time;
obtaining current processing statuses for the work items;
calculating priority indexes for the work items;
determining whether a priority index of any work item is greater than or equal to a corresponding warning index; and
generating a warning alarm and transmitting the warning alarm to an operator for processing a work item preferentially if the priority index of the work item is greater than or equal to its warning index.
